(19) United States
(12) Patent Application Publication
(10) Pub. No.: US 2016/0017511 A1
(43) Pub. Date: Jan. 21, 2016

(54) ELECTROCHEMICAL CHARACTERIZATION OF PLATING SOLUTIONS AND PLATING PERFORMANCE

(71) Applicant: TECHNIC, INC., CRANSTON, RI (US)

(72) Inventors: KAZIMIERZ J. WIKIEL, WAKEFIELD, RI (US); ALEKSANDER R. JAWORSKI, FRANKLIN, MA (US); WOJCIECH A. WIKIEL, CRANSTON, RI (US)

(21) Appl. No.: 14/795,905

(22) Filed: Jul. 10, 2015

Related U.S. Application Data
(60) Provisional application No. 62/026,168, filed on Jul. 18, 2014.

(51) Int. Cl. C25D 21/12; G06F 17/50; G01N 27/42

(52) U.S. Cl. CPC C25D 21/12; G01N 27/42; G06F 17/5009

(57) ABSTRACT

A process for quantifying, by means of soft modeling, the characteristics of an electroplating solution is provided. The process includes (a) obtaining a sample set, wherein each sample comprises a plating solution of proper performance, (b) obtaining an electrochemical response (in form of a tensor) for each of the sample to produce a multi-way electrochemical response data set, (c) obtaining a training set that comprises the sample set and corresponding the multi-way electrochemical response data set, (d) analyzing the training set by soft modeling using multi-way decomposition method coupled with outlier-detection analysis methods to produce a outlier-detection parameters data set, and (e) validating said training data set by soft modeling to produce the multi-way predictive data set for a predictive model.

### FIELD OF THE INVENTION

The invention relates generally to monitoring the performance of plating solutions. More specifically, the invention relates to electrochemical plating baths and methods for monitoring plating functionality based on kinetic and chemometric analysis of voltammetric data obtained for these baths. Chemometric techniques are applied to build a predictive model that allows direct soft modeling-based evaluation of plating bath performance without compromising a capability of obtaining hard modeling physicochemical parameters.

### BACKGROUND OF THE INVENTION

Modern electroplating processes are widely used for the manufacturing of semiconductor parts and devices. Several electroplating processes are commonly used for so called Damascene processes process as well as TSV (through-silicone-vias) filling. Being a part of manufacturing of sophisticated and very highly integrated circuits, these processes require rigorous monitoring. One monitoring system, the Real Time Analyzer (Technic, Inc., Cranston, RI) allows control of electroplating solutions to the extent expected in the highly demanding semiconductor manufacturing. The system performs an in-situ analysis using exclusively electroanalytical techniques for the bath constituents.

The advantages of using electroanalytical measurements to monitor and/or control plating bath solution include direct (as opposed to indirect requiring sample pretreatment) analysis and non-invasiveness. Such electroanalytical methods perform activities very similar to those performed by the electroplating processes themselves, but at a significantly smaller scale. By directly analyzing the undiluted plating bath solution using such electrochemical methods, the RTA approach provides accurate measurements of each added constituent of the bath and can characterize the plating bath performance while plating is in process, thereby enabling early fault detection to minimize waste.

Although knowledge of bath constituent concentrations is absolutely necessary for process control, it is not sufficient to predict changes caused by accumulation of breakdown products and/or foreign contaminants. In U.S. Pat. No. 7,124,120 [1], we disclosed methods for plating bath performance fault detection using a number of chemometric techniques including modeling power, outlier detection, regression and calibration transfer for analysis of the voltammetric data obtained for various plating baths.

Electroplating solutions are dynamic analytes because their constituents undergo degradation, generating the breakdown products that can contribute to plating performance. This process is called bath aging. Also, the presence of foreign contaminants (for instance drag-in contaminants) may affect electrodeposition process performance, even if the concentrations of all deliberately added bath constituents are at their target level. Therefore, in order to characterize plating performance of the electroplating bath, it is not sufficient to focus only on monitoring of concentrations of deliberately added constituents.

The traditional approach to evaluating electroplating bath performance is to run a functional, non-quantitative test called the Hull cell test [2-4]. The Hull cell test has been recognized as one of the most important tools to monitor overall performance of plating solutions. The electrochemical setup used for this test consists of a trapezoidal cell (Hull cell) and rectifier that provides constant current. Due to the Hull cell trapezoidal shape, the method exploits well defined current distribution characteristics at the metallic cathode, and deposits metal at different current densities (at different segments of the Hull cell panel). Then, the deposit is visually examined and establishes a pattern to be followed. The Hull cell is a functional, non-quantitative test and is a subject to person-to-person inconsistency. But if used by an experienced and consistent developer/plater, it gives valuable information to the user, helping to evaluate and run electroplating bath effectively.

The Hull cell's trapezoidal shape allows creating a variation in solution resistance between the electrodes, resulting in a large variation in current density across the deposition of the test panel. However, the solution agitation methods used in the Hull cell result in poorly reproducible mass transfer characteristics between experimental runs. Abys et al. [5,6] introduced a hydrodynamically modulated Hull cell that combines in a single unit the capability of providing for well-defined cell hydrodynamics and measuring wide range of current densities on a single experiment by using a cylindrical rotating cathode and an anode positioned to provide a non-uniform current distribution. As in the original Hull cell design, the hydrodynamically modulated Hull cell provides only functional, non-quantitative testing capability.

Lu [7] patented a new test cell design which permits assessment of deposit characteristics at various current densities on a single test panel and also has reproducible mass transfer characteristics and could be useful for quantitative measurements. This test cell has a cathode rotatable about its central axis.

There have been several attempts to quantify Hull cell test results. One of the recent attempts uses a cell with a segmented cathode (Landau, U.S. Pat. No. 6,884,333) [8], instead of using a cell with trapezoidal geometry (to obtain a pattern of different current densities). Each segment of the cathode is plated at different current density. The response (potential) is recorded and analyzed. The analysis quantifies the kinetic parameters of the electroplating bath (Tafel's parameters) by fitting the data into analytical equations derived by hard modeling. The parameters obtained by that fitting are used in the quantitative characterization of plating bath. The interpretation of obtained physicochemical parameters requires highly skilled operator especially for detecting a physically improbable combination of parameters which mathematically provide a good fit.

Ogden et al. [9] have proposed a method of determining the plating properties of a plating bath by first forming a test specimen from plated material and then tensile strength testing the specimen to determine the mechanical properties of the material. In this method, a band of material is formed by plating the material onto a cylindrical cathode sandwiched between a pair of insulating end pieces. In order to provide uniform, reproducible solution mass transport to the surface being plated the cathode is rotated about its axis.

Moçotéguy et al. [10] and Gabrielli et al. [11-13] have employed electrochemical impedance spectroscopy (EIS) to investigate copper bath ageing in copper damascene processes. A kinetic-based model is used to simulate the impedance scans by taking into account the organic additives in the reaction mechanism. The model is fitted to the experimental results indicating that low frequency impedance relaxations change as the plating bath ages experiencing additive depletion and degradation. The approximate measure of the diameter of the low frequency impedance loops was concluded to be easiest way to devise a protocol for following bath ageing and bath renewal.

D′Urzo et al. [14, 15] have developed a method to monitor the stability of industrial proven plating baths for copper damascene process, and to study the behavior of by-products of organic additives by Solid Phase Extraction-High-Performance Liquid Chromatography (SPE-HPLC). Bath monitoring is based on analysis of a few peaks corresponding to deliberately added bath constituents and their selected degradation products. As in all separation-based techniques this method does not take into account a synergy/co-operation between all bath constituents resulting in the plating performance. Relative concentrations between additives and degradation products play a key role in defining their impact on the copper deposition. However, the plating process is not a subject of investigation by SPE-HPLC method, but rather some of the extracted components (not including for instance foreign contaminants) contributing to this process.

Vidal et al. [16, 17] have developed a method of assessing plating performance based on chemometric image analysis of scanned plated sheets. In the approach, digital images of plated steel sheets in a nickel bath are acquired with a flatbed scanner and are used to follow the process under degradation of specific additives. The obtained digitized information of flat surfaces is subsequently explored by Principal Component Analysis (PCA) to find significant differences in the coating of sheets, to find directions of maximum variability, and to identify odd samples. This method provides a relatively inexpensive analytical measurement for assessing the quality of coated metallic surfaces and for monitoring electrochemical bath life. In this method, Partial Least Squares (PLS) regressions are calculated correlating changes in images with concentration of bath additives. However, the robustness of these calibrations in the presence of accumulating degradation products has not been studied.

Dow et al. [18] present a method of monitoring the filling performance of a copper plating solution used for manufacturing of multilayer printed circuit boards. This method uses the potential difference between two polarization curves obtained from galvanostatic measurements at different flow rates, which can serve as an effective indicator of filling performance, because a linear function can correlate the potential difference with the filling performance. The shift of the polarization curve of the working solution after a period of operation can be regarded as an accumulation of by-products.

Although copper electroless deposition (ELD) is being used during the processing of printed circuit boards (PCB) and more recently as a seed layer in TSV processes, there are only a few reports in literature that focus on controlling bath stability under these conditions [19,20]. Inoue et al. [19] have proposed a method combining UV-VIS spectra as well as measurement of mixed potential and pH measurement for determining of degradation of an electroless copper solution. The pH of the solution gradually decreases due to consumption of hydroxide ion for the base reaction of copper reduction and the Cannizzaro reaction of glyoxylic acid. The simultaneously occurring increase of UV-VIS absorbance is caused by Cu-EDTA complexation. Park et al. [20] have conducted evaluation of the stability and reactivity of copper ELD solution by in-situ transmittance measurement. The change of transmittance with the size of copper particles is observed by the injection of SnPd colloids. Based on the relationship between transmittance and copper particle growth, in-situ monitoring is employed to determine the effect of complexing agents, the important elements in determination of solution performance, on stability and reactivity.

### SUMMARY OF THE INVENTION

U.S. Pat. Nos. 7,124,120 [1] and 7,270,733 [21] relating to the Technic RTA are herein incorporated by reference for the substance of its disclosure.

The invention disclosed herein employs an approach different from the approach disclosed in the Landau patent [8] as it enables direct, soft-modeling based bath characterization, without compromising a capability of interpretation of physicochemical parameters obtained by fitting the data into analytical equations. The apparatus comprises of a Multi-Task Electroanalytical Probe (MTEP) of the Real Time Analyzer (RTA). The MTEP is a simple 3-electrode cell. Different electrical waveforms (constant current and/or constant potential) are employed sequentially to the small portion of plating solution pumped into the probe measurement compartment. The apparatus is shown in FIG. 1. When a small portion of plating solutions is pumped into the measurement compartment of MTEP, the valves are energized closing the loop. Then the electrical waveform (constant current, and/or constant potential, and/or any arbitrary waveform) is employed. The data is recorded into the computer memory. Subsequently, the solution inside the probe is removed (valves open again), and the new portion of solution is pump in for recording of another set of data with different waveform (constant current, and/or constant potential, and/or any arbitrary waveform). This operation is repeated as many times as it is necessary to build an appropriate data set. Then, the obtained data set is analyzed by soft modeling to provide directly an overall bath-performance score. The system offers an option to obtain additionally electrochemical parameters, however the interpretation of these parameters is not necessary for performing soft modeling based bath characterization. The soft modeling chemometric bath characterization routine is direct, without going through interpretation of fitted physicochemical parameters of hard-modeling analytical equations. By direct soft modeling analysis there is no risk of incorrect interpretation in case the chosen hard model is inadequate for the studied solution. The block diagram of basic operations is presented in FIG. 2.

For this application the RTA, which is a universal analytical system, is applied as a second-order instrument which generates a matrix (a second-order tensor) for each data sample. Each sample is characterized by a matrix of dependent variables (measured potential) recorded for a combination of two independent variables (set current density and time). A collection of 2^{nd} order data from each of many samples in a training set creates a third order tensor (three-way array) that could be used to form 2^{nd} order analytical model estimated by 2^{nd} order decomposition method. Such three-way array data sets are decomposed in factor analysis for the purpose of data compression and information extraction by multi-way chemometric techniques like PARAlell FACtor Analysis (PARAFAC) [22,23], Tri-Linear Decomposition (TLD) [23], or Tucker models [23]. This way, the presented method provides not only all parameters that could be obtained by Landau [8], but it provides an overall score for the plating bath performance. The obtained scores can subsequently be subjected to various chemometric outlier detection methods (for instance those based on versions of Mahalanobis Distance [24] or Hotelling's T²) or pattern recognition by means of classification techniques (e.g. Soft Independent Modelling of Class Analogy [SIMCA]).

The same treatment can be repeated for constant potential experiment results and/or for combination of constant-current and constant-potential. This way, a comprehensive quantitative characterization of plating solution can be delivered.

This approach has very clear advantage to the Landau's patent's segmented cathode method [8] without compromising any of the analytical information obtainable from the method disclosed in the Landau patent. There is no need for a special cell, and all results can be obtained by using a very simple and inexpensive probe. Additionally, a totally different soft-modeling based data analysis method provides a full and comprehensive characterization of plating solution that can be easily correlated with plating bath performance. As a result, io a quantitative method is provided for monitoring bath “health” that includes quantification of effects of accumulated breakdown product and/or contaminants on bath performance.

### BRIEF DESCRIPTION OF THE DRAWINGS

FIG. 1 is a schematic drawing of apparatus to run sequential waveforms and measure the response. The internal electrodes (3-electrode cell, not visible in this picture) are connected to the computer controlled potentiostat. A: Schematic of valves operation (closing and opening solution loop).

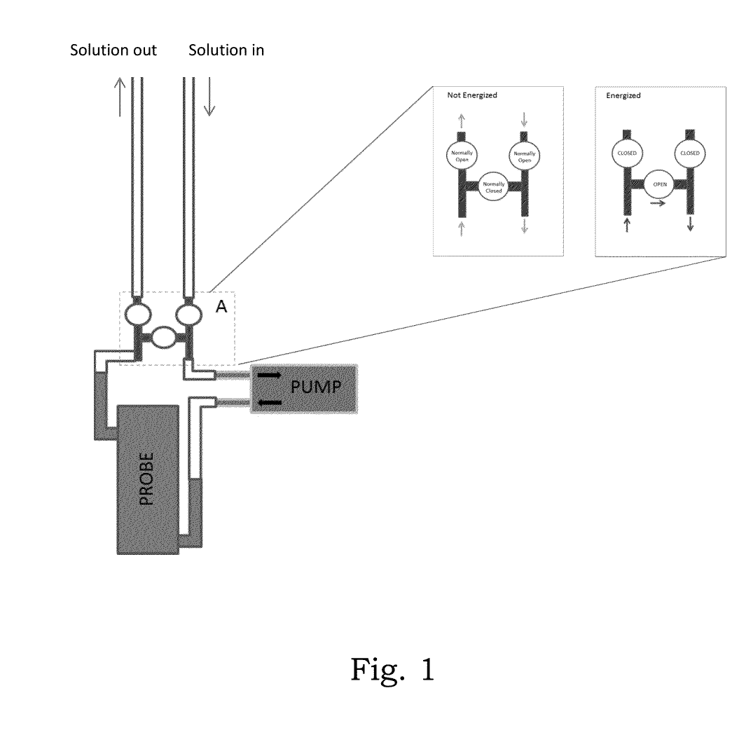

FIG. 2 is a block diagram of the process of the invention.

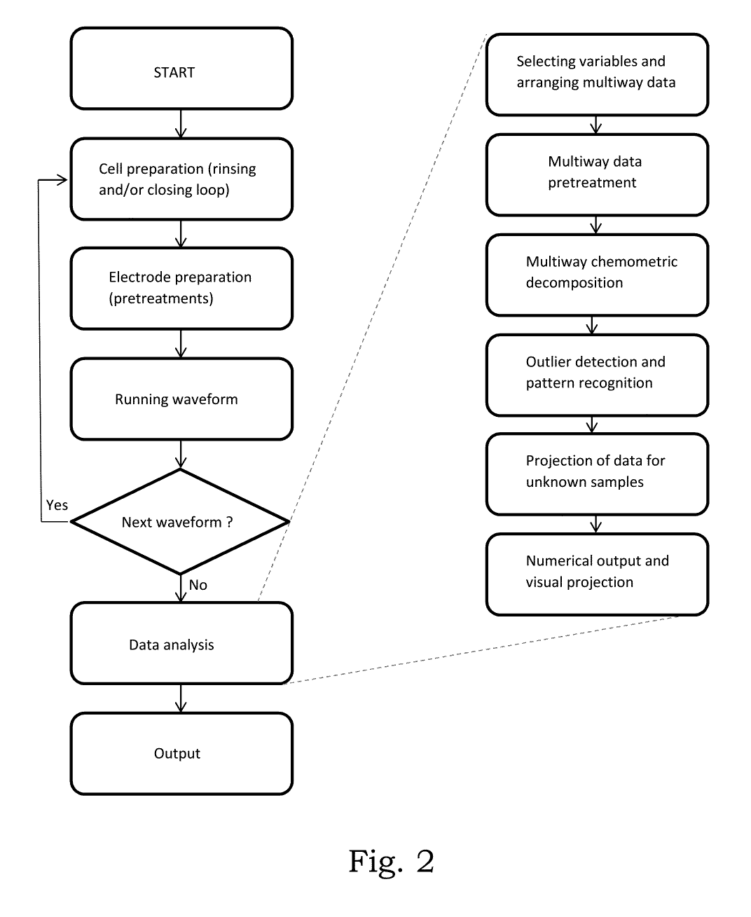

FIG. 3 is a reproduction of a Mahalanobis distance ellipsoid surrounding the training set cluster.

### DETAILED DESCRIPTION OF THE INVENTION

For this application the RTA, which is a universal analytical system, is applied as a second-order instrument which generates a matrix (a second-order tensor) for each data sample. Each sample is characterized by a matrix of dependent variables (measured potential) recorded for a combination of two independent variables (set current density and time), X^{(J×K)}, where J is the number of set current densities while K is the number of time points when the potential was sampled. A collection of 2^{nd} order data from each of many samples in a training set (of the total of I) creates a third order tensor (three-way array), X^{(I×j×K)} that could be used to form 2^{nd} order analytical model estimated by 2^{nd} order decomposition method. Such three-way array data sets are decomposed in factor analysis for the purpose of data compression and information extraction by multi-way chemometric techniques like Generalized Rank Annihilation Method (GRAM) [23], PARAlell FACtor Analysis (PARAFAC) [22,23], Tri-Linear Decomposition (TLD) [23], or Tucker models [23]. Out of these decomposition techniques the PARAFAC is most commonly used, and therefore was selected as an example to explain the applied throughout this patent chemometric methodology. PARAFAC is a trilinear decomposition technique. In the three-way analysis a decomposition of data is made into triads. Instead of one score vector and one loading vector (dyad) as in bilinear Principal Component Analysis (PCA), each component consists of one score vector and two loadings vectors (triad). In contrast to PCA, PARAFAC does not require orthogonality to identify the model. The PARAFAC model of a three-way array is given by a three loading matrices A, B, and C with typical elements a_{if}, b_{jf}, and c_{kf}:

$${\hat{x}}_{ijk} = {\sum }_{f = 1}^{F} {a}_{if} {b}_{jf} {c}_{kf} \qquad ( 1 )$$

The PARAFAC structural model can also be written as

$${\hat{X}}^{( I \times JK )} = {\sum }_{f = 1}^{F} {a}_{f} ( {c}_{f}^{T} ⊗ {b}_{f}^{T} ) \qquad ( 2 )$$

where \hat{X}^{(I×JK)} is the three-way model unfolded to an I×JK matrix. Unfolding is a way of rearranging a multi-way array to a matrix by concatenating matrices for different levels. The symbol \textcircled{×} denotes a Kronecker tensor product, which for matrices X and Y where X is of size I×J is defined as:

$$X ⊗ Y = [ \begin{matrix}{x}_{11} Y & … & {x}_{1 J} Y \\ ⋮ & ⋱ & ⋮ \\ {x}_{I 1} Y & … & {x}_{I J} Y\end{matrix} ] \qquad ( 3 )$$

The PARAFAC model can be formulated in terms of the unfolded array as

X^{(I×JK)}=A(C|\textcircled{x}|B)^{T}+E^{(I×JK)} (4)

where the operator |\textcircled{0}| denotes a Khatri-Rao product, which for the matrices X and Y having the same number of columns, F, is defined as:

X|\textcircled{×}|Y=[x₁ \textcircled{×} y₁ x₂ \textcircled{×} y₂ . . . x_{F} \textcircled{×} y_{F}] (5)

The PARAFAC model is an approximate solution of the loss function:

$${min}_{A , B , C} {‖ X - {A ( C \vert ⊗ \vert B )}^{T} ‖}_{F}^{2} \qquad ( 6 )$$

where X^{(I×JK)} is the three-way array X^{(I×J×K)} unfolded to an I×JK matrix. The operator |\textcircled{×}| denotes a Khatri-Rao product.

Usually when using an existing model on new data, one is interested in estimating the loading of the first mode of new, unknown samples. Assuming that the first mode refers to samples the estimation of the scores aᵤ^{(I×F)} of the unknown sample Xᵤ^{(J×K)} (becoming after the unfolding a row vector xᵤ^{(I×JK)} is calculated via following expression:

aᵤ=xᵤ[(C|\textcircled{×}B)⁺]^{T} (7)

The vector of residuals eᵤ^{(I×JK)} of the unknown sample can be obtained employing following equation:

eᵤ=xᵤ{1−[(C|\textcircled{×}B)(C|\textcircled{×}B)⁺]^{T}} (8)

where I^{(JK×JK)} is the identity matrix.

Application of the proper preprocessing is an important aspect of the multiway analysis. Before implementing the PARAFAC decomposition the three-way array of electrochemical data was single-centered across the first mode and subsequently scaled within the second mode.

By implementing multi-way techniques, the presented method provides not only all parameters that could be obtained by Landau [8], but also it provides directly an overall score characterizing the plating bath performance. The obtained scores can subsequently be subjected to various chemometric outlier detection methods (for instance those based on versions of Mahalanobis Distance [24] or Hotelling's T²) or pattern recognition by means of classification techniques (e.g. Soft Independent Modelling of Class Analogy [SIMCA]). As an example of the outlier detection technique the Mahalanobis Distance was presented in greater details. The Mahalanobis Distance (D) [24] is a statistical measure of sample distance from the training set mean. The squared D coupled with PARAFAC is defined by the following equation:

Dᵤ²=aᵤM⁻¹aᵤ^{T} (9)

where M is the Mahalanobis matrix:

$$M = \frac{{A}^{T} A}{I - 1} \qquad ( 10 )$$

The modification of Mahalanobis Distance by combining it with Q-residuals leads in many cases to significant increase of outlier detection capability. Application of residuals significantly improves the sensitivity of the determinant analysis as compared to analysis based purely on the PARAFAC loadings. The electrochemical residual can be obtained by subtracting electrochemical signal reconstructed from PARAFAC loadings from the original electrochemical signal. PARAFAC reconstructs the unknown electrochemical signals using the loadings B and C obtained for the predominant variances within training set. Such reconstruction is not efficient in case there are other sources of variance in unknown electrochemical signals absent in the training set. This in turn results in substantial residuals

By calculating sum of squares of the electrochemical signal residuals across all the selected J points of K electrochemical signals (known as Q-residuals) an additional representative value can be generated for each i-th sample of the training set:

$${q}_{i} = {\sum }_{j = 1}^{J} {\sum }_{k = 1}^{K} {e}_{ijk}^{2} \qquad ( 11 )$$

The I values of Q-residuals constitute a column vector q^{(1×1)} which is then i meancentered by subtracting q̅ defined as

$$\overline{q} = \frac{{\sum }_{i = 1}^{I} {q}_{i}}{I} \qquad ( 12 )$$

from each i-th element of the training set to obtain:

q̅ᵢ=qᵢ− q̅ (13)

The column vector of meancentered Q residuals \tilde{q}^{(1×1)} is appended as a F+1 column to the matrix of loadings of the first mode of the training set A^{(I×F)} to form a residual augmented matrix T^{(I×(F+1)}. The matrix T is used to calculate—the Mahalanobis matrix with Q residuals M_{Q} defined as:

$${M}_{Q} = \frac{{T}^{T} T}{I - 1} \qquad ( 14 )$$

By analogy to Equation 9 for D, the Mahalanobis Distance with Q residuals (D_{Q}) for the unknown sample is calculated via following expression:

D_{Qu}²=tᵤM_{Q}⁻¹tᵤ^{T} (15)

where tᵤ^{(I×(F+1))} is the unknown sample vector of loadings of the first mode aᵤ appended by Q residual centered with the parameters of the training set, \tilde{q}ᵤ:

tᵤ=[aᵤ \tilde{q}ᵤ] (16)

where

\tilde{q}ᵤ=qᵢ− q̅ (17)

Analogously to Equation 11 for the training set, the elements of the vector of residuals for the unknown sample eᵤ^{(1'JK)} (obtained via Equation 8) are employed to calculate Q residuals corresponding to that unknown sample:

$${q}_{u} = {\sum }_{j = 1}^{J} {\sum }_{k = 1}^{K} {e}_{ujk}^{2} \qquad ( 18 )$$

This treatment can also be conducted for constant potential experiment results and/or for combination of constant-current and constant-potential. This way, a comprehensive quantitative characterization of plating solution can be delivered.

### EXAMPLE

This example presents the organization of several physicochemical parameters characterizing bath performance including: current efficiency and slope and intercept of polarization curve into a multivariate training set subjected subsequently to factor analysis and outlier detection techniques for defining a cluster in eigenvector space of properly performing baths.

A bath solution having the following concentration of Technic copper of constituents is used:

| | | |
|---|---|---|
| copper | 17-20 | g/L |
| sulfuric acid | 9-11% | v/v |
| chloride | 50-70 | mg/L |
| brightener | 2-8 | mL/L |
| carrier | 2-8 | mL/L |

Training set data was collected for eight solutions composed according to two-level, 5-component fractional factorial [25], with levels determined by calibration ranges. Additionally, the data recorded for a ninth solution of a Target composition composed of:

| | | |
|---|---|---|
| copper | 18.8 | g/L |
| sulfuric acid | 10% | v/v |
| chloride | 60 | mg/L |
| brightener | 5 | mL/L |
| carrier | 5 | mL/L |

was augmented to the training set. Each solution was analyzed 10 times, therefore the training set consisted of I=9×10=90 samples.

Current efficiency was measured by dividing the integrated-over-time current of anodic voltammetric peak by the total cathodic charge value of the immediately preceding coulometric measurement. The coulometric measurements were conducted for six different current densities, each producing a j-th variable for the training set data. Additionally, the j variables of the training set are augmented by slope and intercept data of polarization curves drawn for different times.

For brevity of presentation a limited number of variables (J=17) was chosen, therefore it is justified to use for data compression and information extraction a two-way decomposition technique Principal Component Analysis (PCA) [25,26] rather than multi-way decomposition techniques. However, the presented method is general can also chemometrically process multi-way data arrays.

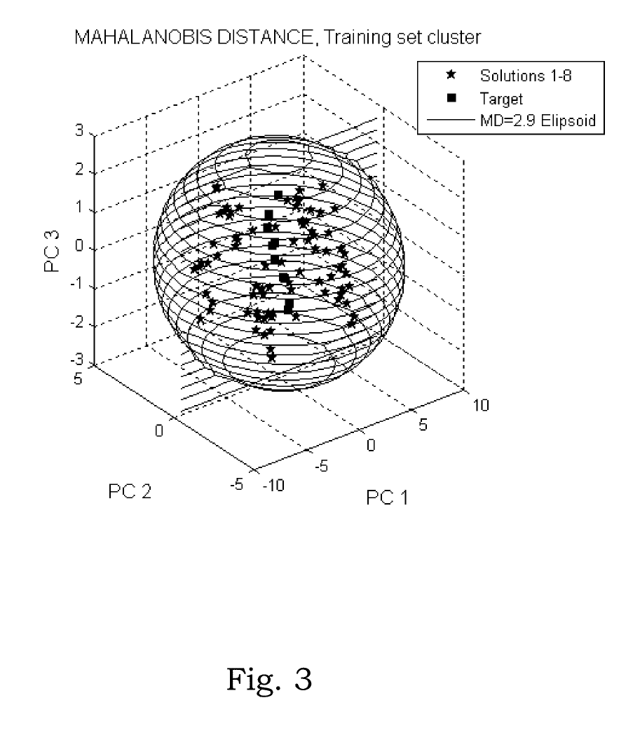

The autoscaled training set matrix X^{(I×J)} is decomposed by PCA into a matrix of scores A^{(I×F)} and loads BP×F) for the number of factors F=3. The scores of the training set form the cluster presented in FIG. 3. In order to distinguish the subset of the training set corresponding to the data of Target solution, the symbol of square was used while the remaining data corresponding to eight solutions was presented symbolized by pentagrams. The scores corresponding to the Target solution's data are located centrally within the cluster. The entire training set cluster is surrounded by an ellipsoid consisting of equidistant points in the sense of Mahalanobis distance [24] (Equation 9) corresponding to the maximum value obtained by take-one-out cross-validation within the training set [28] of 2.9. All solutions, whose corresponding scores are located within the training set ellipsoid, are considered proper in terms of their plating performance (like all the data of the training set). The solutions, whose corresponding scores are positioned beyond the training set ellipsoid, are considered outliers, and characteristics of their plating performance can differ from that of the training set. The scores for unknown samples are obtained by projecting their data of the eigenvector space of the training set.

All patents, publications and other references cited herein are hereby incorporated by reference. Although the invention has been particularly described with reference to certain embodiments, skilled artisans appreciate that changes in form and detail may be made without departing from the scope of the appended claims.

### REFERENCES

[1] K. J. Wikiel, A. Jaworski, and H. Wikiel, Method and Apparatus for Real Time Monitoring of Electroplating Bath Performance and Early Fault Detection, U.S. Pat. No. 7,124,120 (2006).
[2] R. O. Hull, Apparatus and Process for the Study of Plating Solutions, U.S. Pat. No. 2,149,344 (1939).
[3] R. O. Hull and J. B. Winters, Apparatus for the Determination of Plating Characteristics of Plating Baths, U.S. Pat. No. 2,801,963 (1957).
[4] R. O. Hull Jr. and J. A. Zelmder, Analytical Electroplating Apparatus, U.S. Pat. No. 3,121,053 (1961).
[5] J. A. Abys, and I. V. Kadija, Hydrodynamically modulated Hull cell, U.S. Pat. No. 5,288,976A (1993).

[6] J. A. Abys, and I. V. Kadija, Hydrodynamically modulated Hull cell, U.S. Pat No. 5,413,692A (1995).
[7] P.-Y. Lu, Electroplating Test Cell, U.S. Pat. No. 5,268,087 (1993).
[8] U. Landau, Electrochemical System for Analyzing Performance and Properties of Electrolytic Solutions, U.S. Pat. No. 6,884,333 B2 (2005).
[9] C. A. Ogden, D. M. Tench, and J. T. White, Method of determining the plating properties of a plating bath, U.S. Pat. No. 4,252,027 (1981)
[10] P. Moçotéguy, C. Gabrielli, H. Perrot, A. Zdunek, and D. Nieto Sanz, J. Electrochem. Soc. 153 (12) (2006) G1086.
[11] C. Gabrielli, P. Moçotéguy, H. Perrot, A. Zdunek, and D. Nieto Sanz, J. Electrochem. Soc. 154 (1) (2007) D13.
[12] C. Gabrielli, P. Moçotéguy, H. Perrot, A. Zdunek, and D. Nieto Sanz, J. Electrochem. Soc. 154 (3) (2007) D163.
[13] C. Gabrielli, P. Moçotéguy, H. Perrot, D. Nieto Sanz, and A. Zdunek, J. Appl. Electrochem. 38 (2008) 457.
[14] L. D′Urzo, H.-H. Wang, A. Pa, and C. Zhi, J. Electrochem. Soc. 152 (4) (2005) C243.
[15] L. D′Urzo, H.-H. Wang, C. Tang, A. Pa, and C. Zhi, J. Electrochem. Soc. 152 (10) (2005) C697.
[16] M. Vidal, J. M. Amigo, R. Bro, M. Ostra, C. Ubide, and J. Zuriarrain, Anal. Chim. Acta 694 (2011) 38.
[17] M. Vidal, J. M. Amigo, R. Bro, van den Berg, M. Ostra, and C. Ubide, Anal. Chim. Acta 706 (2011) 1.
[18] W.-P. Dow, M.-Y. Yen, C.-W. Chou, C.-W. Liu, W.-H. Yang, and C.H. Chen, Electrochem. Solid-State Lett. 9 (2006) C134.
[19] F. Inoue, H. Philipsen, A. Radisic, S. Armini, Y. Civale, S. Shingubara, and P. Leunissen, J. Electrochem. Soc. 159 (7) (2012) D437.
[20] K. J. Park, H.-C. Koo, T. Lim, M. J. Kim, O. J. Kwon, and J. J. Kim, J. Electrochem. Soc. 158 (9) (2011) D541.
[21] K. J. Wikiel, A. Jaworski, H. Wikiel, D. P. Hazebrouck, Method and Apparatus for Real Time Monitoring of Industrial Electrolytes, U.S. Pat. No. 7,270,733 (2007).
[22] R. Bro, Chemom. Intell. Lab. Syst. 38 (1997) 149.
[23] A. Smilde, R. Bro, and P. Geladi, Multi-way Analysis with Applications in the Chemical Sciences, Wiley (2004).
[24] R. De Maesschalck, D. Jouan-Rimbaud, and D. L. Massart, Chemom. Intell. Lab. Syst. 50 (2000) 1.
[25] G. E. P. Box, W.G. Hunter; and J. S. Hunter, Statistics for Experimenters. An Introduction to Design, Data Analysis, and Model Building, Wiley (1978).
[26] I. T. Jolliffe, Principal Component Analysis, 2^{nd} Ed., Springer (2002).
[27] E. R. Malinowski, Factor Analysis in Chemistry, 3^{rd} Ed., Wiley (2002).
[28] M. Stone, J. Roy. Statist. Soc. B36 (1974) 111.

1. A process to produce a predictive multi-way data set which can be used to quantify by means of soft modeling the characteristics of a plating solution, said process comprising:
(a) obtaining a sample set, wherein each sample comprises a plating solution of proper performance;
(b) obtaining an electrochemical response (in form of a tensor) for each said sample to produce a multi-way electrochemical response data set;
(c) obtaining a training set that comprises said sample set and corresponding said multi-way electrochemical response data set;
(d) analyzing said training set by soft modeling using multi-way decomposition method coupled with outlier-detection analysis method to produce a outlier-detection parameters data set;
(e) validating said training data set by soft modeling to produce said multi-way predictive data set for a predictive model.

2. A process according to claim 1 wherein said property comprises an overall plating performance.

3. A process according to claim 1 wherein said property comprises a concentration of individual component of said electroplating bath.

4. A process according to claim 1 wherein said property comprises an amount of breakdown products accumulated in said electroplating bath.

5. A process according to claim 1 wherein said property comprises an amount of foreign contaminants accumulated in said electroplating bath.

6. A process according to claim 1 wherein said property comprises a combination of one or more properties of claims 3-5.

7. A process according to claim 1 wherein said plating solution is an electroplating bath.

8. A process according to claim 1 wherein said plating solution is a bath selected from the group consisting of an electrowinning bath, an electrorefining bath, an electroforming bath, an electromicromachining bath, and an electropolishing bath.

9. A process according to claim 1 wherein said plating solution is an electroless plating bath.

10. A process according to claim 2 wherein said overall plating performance comprises properties selected from the group consisting of throwing power, brightness of the deposit, tensile strength of the deposit, ductility of the deposit, internal strength of the deposit, solderability performance, resistance to thermal shock, uniformity of the deposit, and capability of uniform defect-free of micrometer-, submicron-, and nanometer size features in the substrate surface.

11. A process according to claim 7 wherein said electroplating bath comprises a plating bath of Cu, Sn, Pb, Zn, Ni, Ag, Cd, Co, Cr, and/or their alloys.

12. A process according to claim 9 wherein said electroless plating bath comprises is a bath selected from the group consisting of autocatalytic plating bath and immersion plating bath of Cu, Sn, Pb, Ni, Ag, Au and/or their alloys.

13. A process according to claim 1 a wherein said sample set comprises plating solutions of known concentration within specification range.

14. A process according to claim 1 a wherein said sample data set is obtained by design of experiment (DOE) routines selected from the group consisting of multicomponent multilevel linear orthogonal array and multicomponent multilevel fractional factorial.

15. A process according to claim 1 a wherein said sample set comprises freshly prepared electroplating solutions of known concentration within specification range.

16. A process according to claim 1 a wherein said sample set comprises industrial plating solutions with well performance (empirical sample set).

17. A process according to claim 1 wherein the electrochemical response of step (b) is obtained by a method selected from the group consisting of tensorial Chronoamperometry by multi-order instrument, tensorial Chronopotentiometry by multi-order instrument, tensorial Electrochemical Impedance Spectroscopy technique by multi-order instrument and a combination of any two or more of the foregoing techniques.

18. A process according to claim 1b wherein said electrochemical response comprises a plurality of data points.

19. A process according to claim 1b wherein said electrochemical response is a combination of one or more portions of a complete electrochemical response.

20. A process according to claim 1b wherein said electrochemical response comprises a combination of one or more portions of independent electrochemical responses.

21. A process according to claim 1 d wherein said multi-way decomposition method is selected from Parallel Factor Analysis (PARAFAC), Generalized Rank Annihilation Method (GRAM), Trilinear Decomposition (TLD), any of the Tucker models, and Multi-way Principal Component Analysis (MPCA).

22. A process according to claim 1 d wherein said outlier detection analysis method is selected from Mahalanobis Distance (MD), Mahalanobis Distance with residuals (MDR), Simple Modeling of Class Analogy (SIMCA), and Fs ratio.

23. A process according to claim 1 e wherein said validation is accomplished through internal validation and crossvalidation.

24. A process to predict the property of said plating solution, said process comprising:
(a) producing a predictive multi-way data set, the predictive multi-way data set generated by:
(a1) obtaining a sample set, wherein each sample comprises an electrolyte solution of proper performance;
(a2) obtaining an electrochemical response for each said sample to produce a multi-way electrochemical response data set;
(a3) obtaining a training set that comprises said sample set and corresponding said multi-way electrochemical response data set;
(a4) preprocessing of said multi-way electrochemical response data set;
(a5) analyzing said training set by soft modeling using multi-way decomposition method coupled with outlier detection method to produce outlier detection parameters data set;
(a6) validating said training data set by soft modeling to produce said multi-way predictive data set for a predictive model;
(b) using said predictive multi-way data set to predict the property of said plating solution, said property predicted by:
(b1) obtaining an unknown sample set, wherein each unknown sample in said unknown sample set contains a plating solution;
(b2) obtaining a multi-way electrochemical response for each said unknown sample to produce a multi-way electrochemical response data set;
(b3) preprocessing of said multi-way electrochemical response data set;
(b4) applying said predictive model to predict property of each said unknown sample by soft modeling.

25. A process to detect faulty performance of said plating solution, said process comprising:
(a) producing a predictive multi-way data set, the predictive multi-way data set generated by:
(a1) obtaining a sample set, wherein each sample comprises an electrolyte solution of proper performance;
(a2) obtaining an electrochemical response for each said sample to produce a multi-way electrochemical response data set;
(a3) obtaining a training set that comprises said sample set and corresponding said multi-way electrochemical response data set;
(a4) preprocessing of said multi-way electrochemical response data set;
(a5) analyzing said training set by soft modeling using multi-way decomposition method coupled with outlier detection method to produce a discriminant parameters data set;
(a6) validating said training data set by soft modeling to produce said multi-way predictive data set for a predictive model;
(a7) specifying the limits of good and faulty performance of said plating solution;
(b) using said multi-way predictive data set to predict by soft modeling the property of said plating solution and qualify said solution as correct or faulty said process comprises:
(b1) obtaining an unknown sample set, wherein each unknown sample in said unknown sample set contains a plating solution;
(b2) obtaining an electrochemical response for each said unknown sample to produce a multi-way electrochemical response data set;
(b3) preprocessing of said multi-way electrochemical response data set;
(b4) applying said predictive model to predict by soft modeling property of each said unknown sample;
(b5) qualifying said unknown samples as correct or faulty.

26. A method of monitoring performance of plating solution in order to perform controlled feed and bleed procedure, said process comprising the steps of:
(a) producing a predictive multi-way data set, the predictive multi-way data set generated by:
(a1) obtaining a sample set, wherein each sample comprises an electrolyte solution of good performance;
(a2) obtaining an electrochemical response for each said sample to produce a multi-way electrochemical response data set;
(a3) obtaining a training set that comprises said sample set and corresponding said multi-way electrochemical response data set;
(a4) preprocessing of said multi-way electrochemical data set;
(a5) analyzing said training set by soft modeling using multi-way decomposition method coupled with outlier detection method to produce outlier detection data set;
(a6) validating said multi-way training data set by soft modeling to produce said multi-way predictive data set for a predictive model;
(a7) defining the limits of said property for said plating solution that requires feed and bleed procedure;
(b) using said multi-way predictive data set to predict the property of said plating solution and qualify said solution as correct or faulty said process comprises:
(b1) obtaining an unknown sample set, wherein each unknown sample in said unknown sample set contains a plating solution;
(b2) obtaining an electrochemical response for each said unknown sample to produce a multi-way electrochemical response data set;
(b3) preprocessing of said multi-way electronalytical response data set;
(b4) applying said predictive model to predict property of each said unknown sample;
(b5) qualifying said unknown samples as a ready or not ready solution for feed and bleed procedure.

27. A method of monitoring performance of electroplating solution in order to perform controlled purification treatment procedure, said process comprising the steps of:
(a) producing a multi-way predictive data set, the predictive data set generated by:
(a1) obtaining a sample set, wherein each sample comprises an electrolyte solution of proper performance;
(a2) obtaining an electrochemical response for each said sample to produce a multi-way electrochemical response data set;
(a3) obtaining a training set that comprises said sample set and corresponding said electrochemical response data set;
(a4) preprocessing of said multi-way electrochemical response data set;
(a5) analyzing said training set by soft modeling using multi-way decomposition method coupled with outlier detection method to produce outlier detection parameters data set;
(a6) validating said training data set by soft modeling to produce said multi-way predictive data set for a predictive model;
(a7) defining the limits of said property for said plating solution that requires purification treatment;
(b) using said multi-way predictive data set to predict by soft modeling the property of said plating solution and qualify said solution as correct or faulty said process comprises:
(b1) obtaining an unknown sample set, wherein each unknown sample in said unknown sample set contains a plating solution;
(b2) obtaining an electrochemical response for each said unknown sample to produce a multi-way electrochemical response data set;
(b3) preprocessing of said multi-way electronalytical response data set;
(b4) applying said predictive model to predict by soft modeling property of each said unknown sample;
(b5) qualifying said unknown samples as ready or not ready for purification treatment.
